(19) United States
(12) Patent Application Publication
(10) Pub. No.: US 2019/0289878 A1
(43) Pub. Date: Sep. 26, 2019

(54) METHODS OF FEEDING ANIMALS FEED PRODUCTS CONTAINING DIRECT-FED MICROBIALS

(71) Applicant: PURINA ANIMAL NUTRITION LLC, Shoreview, MN (US)

(72) Inventors: Bill L. Miller, Labadie, MO (US); Samantha Steelman, Champaign, IL (US); Daniel Grum, Labadie, MO (US); James D. Caldwell, St. Clair, MO (US)

(21) Appl. No.: 15/934,711

(22) Filed: Mar. 23, 2018

(51) Int. Cl. A23K 10/18; A23K 50/60; A23K 50/10; A23K 50/20; A23K 50/30; A23K 50/75

(52) U.S. Cl. CPC A23K 10/18; A23K 50/60; A23K 50/75; A23K 50/20; A23K 50/30; A23K 50/10

(57) ABSTRACT

The present disclosure describes animal feed products formulated to improve animal performance, and methods of feeding such products to the animals. Feeding methods involve providing young livestock animals with a milk replacer that includes a direct-fed microbial composition. Feeding the young livestock animals according to this approach may improve animal performance, which may include improvements in total weight gain, feed efficiency and/or starter feed intake. The direct-fed microbial composition may include Bacillus subtilis PB6, about 4.3×10⁹ to about 12.9×10⁹ CFUs of which may be provided daily on a per-animal basis.

### TECHNICAL FIELD

Implementations relate to feed products and methods of feeding such products to animals. Specific implementations provide methods of feeding milk replacers containing direct-fed microbials to young animals in a manner that improves animal performance.

### BACKGROUND

Young animals require adequate nutrition for healthy growth and development. Robust growth early after birth can be especially important for the long-term development of livestock animals. A number of feeding systems have been used to enhance weight gain of livestock beginning at a young age and may include feeding techniques implemented prior to and after weaning. Some of these techniques may involve providing milk replacer products to the animals. While many milk replacer products have been developed, improved products and novel methods of feeding them are desired to further enhance animal growth.

### SUMMARY

Implementations provide approaches to feeding young livestock animals that involve providing the animals with a milk replacer composition, which contains an amount of direct-fed microbials that results in the animals exhibiting improved performance.

In accordance with some examples of the present disclosure, the direct-fed microbial composition may include Bacillus subtilis PB6. In some embodiments, about 4.3×10⁹ CFUs of the direct-fed microbial composition are provided daily on a per-animal basis. In some examples, the direct-fed microbial composition may be provided daily on a per-animal basis between birth and about 3 weeks of age. In some embodiments, the direct-fed microbial composition may be provided daily on a per-animal basis between birth and about 6 weeks of age. In some examples, about 8.6×10⁹ to about 12.9×10⁹ CFUs of the direct-fed microbial composition are provided daily on a per-animal basis.

In some embodiments, the direct-fed microbial composition is provided daily on a per-animal basis between birth and about 3 weeks of age. In some embodiments, the direct-fed microbial composition is provided daily on a per-animal basis between birth and about 6 weeks of age. In some examples, about 10.75×10⁹ CFUs of the direct-fed microbial composition are provided in a first meal after birth on a per-animal basis. In some embodiments, after the first meal, about 8.6×10⁹ CFUs to about 12.9×10⁹ CFUs of the direct-fed microbial composition are provided daily between birth and about 3 to about 6 weeks of age.

In various examples, animal performance may include total weight gain between birth and about 6 weeks of age. In some embodiments, animal performance may include total feed efficiency between birth and about 6 weeks of age. In some examples, animal performance may include milk replacer feed efficiency between birth and about 6 weeks of age. In some embodiments, a method may further involve feeding the young livestock animals a starter feed composition on an ad libitum basis. According to such examples, animal performance may include total starter feed intake.

### BRIEF DESCRIPTION OF THE DRAWINGS

FIG. 1 is a graph of microbial alpha diversity measured in the microbiome of calves fed according to principles of the present disclosure.

FIG. 2 is a graph of microbial beta diversity measured in the microbiome of calves fed according to principles of the present disclosure.

### DETAILED DESCRIPTION

This disclosure provides methods of feeding young animals a feed product containing direct-fed microbials (“DFMs”), which are live microorganisms and in some cases, live microorganism compositions. In embodiments, the feed product can comprise a milk replacer and the DFM can comprise a strain of Bacillus subtilis, such as Bacillus subtilis, PB6 (“PB6”). Methods of feeding young animals, such as calves, can involve providing an enhanced dose of PB6 in a milk replacer product immediately after birth. After an initial period, e.g., 2-3 weeks, the PB6 dose may be reduced to a less enhanced, or even baseline, dose. Providing PB6-supplemented milk replacer products to young animals according to the methods described herein may accelerate development of the animals' microbiome and improve animal performance. Improved animal performance may be evidenced by increases in total weight gain and starter feed intake, as well as improvements in feed efficiency.

### Milk Replacer Products Containing DFMs

Milk replacers of the present disclosure can include or be admixed with one or more DFMs. After testing many milk replacer additives, the inventor discovered that feeding young animals a milk replacer containing PB6 leads to improvements in animal performance. The improvements may be amplified by feeding higher doses of PB6 earlier after birth.

Freeze-dried aliquots of PB6 can be obtained from the American Type Culture Collection (ATCC) under Accession No. PTA-6737. The identity of PB6 can be confirmed by assessing the fermentation profile using the API biochemical test and/or by ribotyping the bacterial strain, as described for example in U.S. Pat. No. 7,427,299. The concentration of PB6 in the milk replacer may vary according to the time at which the milk replacer product is fed to the young animals. In some examples, PB6 can be mixed with one or more feed components prior to mixing with a milk replacer. In some embodiments, the resulting milk replacer product may be free or substantially free of antibiotics or drugs.

While the examples provided herein are described within respect to DFMs comprised of PB6 bacteria, PB6 may be mixed and grown together with one or more additional bacterial strains to produce a novel bacterial collection having a unique identity. The additional strain(s) can include different species of Bacillus or species obtained from other genera. Combinations of multiple bacterial strains grown together with a PB6 component can be mixed with a milk replacer and provided to animals according to the same methods described herein with respect to pure PB6 strains.

Milk replacers of the present disclosure may be produced according to traditional methods in which the fat and protein components of milk replacers are spray dried and combined into a milk replacer powder comprised of soluble or at least suspendable ingredients. Spray drying processes generally involve maintaining a spray dryer at temperatures between 100° C. to 200° C. so that the spray dried component rapidly heats and loses moisture. Following spray drying, the spray dried powder is subjected to a subsequent heating step, such as in a dryer drum, with an air temperature of between 100° C. to 200° C. in order to further reduce the moisture content of the powder.

The milk replacer can be milk and/or vegetable based, and the nutrient profile generally includes fat and protein. The fat content may range from about 2.25 to about 4.7 wt % of the hydrated milk replacer or from about 8 to about 31 wt % of the milk replacer powder. The level of fat may be tailored for a target animal, e.g., calves, as well as the age of the animals fed. In some examples, a calf milk replacer may include a crude fat content ranging from about 10 to about 20 wt % of the powder or about 3 to about 3.75 wt % of the hydrated milk replacer, and full potential calf milk replacers may include fat from about 25 to about 31 wt % of the powder or about 3.75 to about 4.7 wt % of the hydrated milk replacer. In some embodiments, the powdered milk replacer may have a crude fat content of about 8 to about 12 wt %, about 9 to about 11 wt %, about 10 wt %, about 14 to about 20 wt %, about 16 to about 18 wt %, or about 17 wt %.

Predominant fat sources may be lard, tallow, palm kernel, or coconut oils, alone or in combination. In addition, some fat from lecithin and residual fat (e.g., butter fat, milkfat, or both) may contribute to the fat content in milk replacers.

Protein in milk replacers typically ranges from about 2.2 to about 5.1 wt % of the hydrated milk replacer or about 18 to about 30 wt % of the powder. For traditional calf milk replacers, the protein content may be about 22 wt % of the powder or about 3.3 wt % of the rehydrated milk replacer, and milk replacers formulated for enhanced performance, such as full potential milk replacers, may include protein at about 25 to about 28 wt % of the powder or about 3.9 wt % to about 4.8 wt % of the rehydrated milk replacer.

Protein may be sourced from animal (e.g., milk, plasma, egg, and red blood cells) and vegetable sources and combinations thereof. Milk-derived protein sources are generally referred to as milk proteins and may include whey, casein, skim milk, sodium caseinate, and calcium caseinate. Non-milk proteins (NMPs), such as vegetable protein (e.g., soy protein, hydrolyzed soy protein, hydrolyzed soy protein modified, soy protein isolate, wheat concentrates, wheat isolates, pea concentrates, pea isolates, and/or potato proteins), animal protein (e.g., plasma such as bovine or porcine plasma, egg and red blood cells), and single cell protein, alone or in combination, may be included as a protein source in the milk replacer. Non-milk proteins may contain varying levels of phosphorous. For instance, phosphorous may be present at about 0.65 wt % of soybean meal, at about 0.78 wt % of soy protein isolate, at about 0.68 wt % of hydrolyzed soy protein modified, at about 1.0 wt % of dehulled canola meal, and each of these components may be present in NMP-containing milk replacers. NMPs may account for up to from 1 to about 65%, from about 50 to about 65%, about 55 to 65%, about 55 to 60%, or up to or at about 60 or about 65% of the total protein content, with the balance of protein derived from milk protein; while milk protein may account for about 35 to 99%, about 35 to about 50%, about 35 to 45%, about 40 to 45%, up to about 40%, or up to about 35% of the total protein content in the milk replacer in some examples.

### Methods of Feeding Milk Replacers Containing DFMs

Methods of feeding animals can involve feeding the animals milk replacer containing various concentrations of one or more DFMs. Implementations can involve obtaining a DFM additive and admixing it with a milk replacer, in liquid or dry form, just prior to feeding. Alternatively, the milk replacer product may contain the DFM within the original composition.

Animals fed according to the methods herein can include dairy calves, chicks, piglets, or foals. The animals can be fed the milk replacer compositions between birth and about 1, 2, 3, 6, 12 or 24 weeks of age, or any sub-period therebetween. The feeding period may begin with the first milk replacer feeding immediately after birth.

The amount of PB6 admixed with milk replacer can vary depending on the age of the animals fed. In various embodiments, PB6 can be provided at a higher dose during an initial period of the animals' lives, immediately following birth. The PB6 dose can then be decreased one or more times after birth, e.g., after 1, 2, 3, 4, 5, 6, 7, or 8 weeks. Front-loading the PB6 doses in the milk replacer, such that more colony forming units (CFUs) are present in each milk replacer feed sample, can lead to significant improvements in animal performance. In some embodiments, an enhanced PB6 dose can be offered for about 3 weeks after birth. The animals can then be fed a reduced dose of PB6 for an additional 3 weeks. According to such embodiments, the enhanced dose provided during the initial 3-week period can be about double or triple a baseline dose of about 4.3×10⁹ CFUs of PB6 per head per day. The mass of the PB6 additive may depend on the bacterial concentration thereof. For example, a daily 1× dose comprised of about 4.3×10⁹ CFUs of PB6 may correspond to about 43 mg of a PB6 additive. To provide an equal number of CFUs per animal per day using a less-concentrated PB6 additive, more of the additive can be administered. After the initial period, the enhanced dose can be decreased to the baseline dose and offered to the animals for an additional period of time spanning 1, 2, 3 or 4 weeks. In some examples, the enhanced dose can be reduced to a level that is still above the baseline dose after an initial period. In some examples, the animals can be offered an enhanced dose equal to triple the baseline dose for the first week after birth, followed by an additional 5 to 6 weeks of feeding at the baseline dose. In another embodiment, the animals can be fed an ultra-enhanced dose of PB6, e.g., 5× baseline, for the first feeding after birth, an enhanced dose, e.g., 2× or 3× baseline, for the remainder of the first 3 weeks, and the baseline dose for another 3-4 weeks.

In various embodiments, a per-animal daily baseline dose can be prepared by mixing about 4.3×10⁸ to about 4.3×10¹⁰ CFUs, about 1.0×10⁹ to about 10×10⁹ CFUs, about 3×10⁹ to about 5×10⁹ CFUs, or about 4.3×10⁹ CFUs of PB6 per every about 1.5 to about 2.5 lbs., about 1.25 to about 1.75 lbs., about 1.45 to about 1.55 lbs., about 1.5 lbs., about 2.25 to about 2.75 lbs., about 2.45 to about 2.55 lbs., or about 2.5 lbs. of powdered milk replacer. An enhanced or ultra-enhanced dose can be prepared by multiplying any of the aforementioned amounts of PB6 by 1.5, 2.0, 2.5, 3.0, 3.5, 4.0, 4.5 or 5.0, and mixing with an aforementioned amount of dry milk replacer. For example, in one embodiment, an enhanced daily dose of 3×PB6 can be prepared by admixing about 12.9×10⁹ CFUs of PB6 (4.3×3) with about 1.50 lbs. of dry milk replacer. An enhanced daily dose of 2×PB6 can be prepared by admixing about 8.6×10⁹ CFUs of PB6 (4.3×2) with about 1.50 lbs. of dry milk replacer. Any of the aforementioned amounts of PB6 and milk replacer powder can be scaled as necessary to meet specific feeding needs. For instance, to feed more than one animal, the amounts of PB6 and milk replacer can be multiplied by the same multiplier that is equal to the number of animals to be fed, or a multiplier slightly above the number of animals to ensure that a sufficient volume of milk replacer is produced.

Generally, animals can be offered a fixed amount of milk replacer per day, with varying PB6 concentrations, which may form all or a portion of the animals' daily feed ration. Prior to the onset of weaning, the milk replacer in the feed ration may be offered twice per day, and may generally be divided into equal parts. Milk replacers may be fed in traditional settings at a rate of about 1.50 pounds per head per day on a dry weight basis. In other examples, milk replacers may be fed in traditional settings at a rate of about 2.50 pounds per head per day on a dry weight basis. At the onset of weaning, the animal may be offered one feeding per day, totaling about 0.75 pounds of milk replacer per head per day on a dry weight basis.

Implementations can further involve providing the young animals with a starter feed on an ad libitum basis. Starter feeds, such as calf starter feeds, may include a mixture of one or more of corn, soybean meal, wheat middlings, oats, molasses, fat, ground cotton seed hulls, distillers grains, calcium carbonate, salt, and macronutrients and micronutrients. The starter feed may contain about 45 to about 50 wt % coarse ingredients such as corn, soy and oats; about 16 to 22 wt % protein; about 2 to 3 wt % fat, about 5 to 6 wt % fiber (determined on a NIR basis); about 7 wt % acid detergent fiber; and/or about 6 wt % molasses, the balance including a mixture of other nutrients.

After an initial period of feeding the young animals a PB6-supplemented milk replacer, e.g., between birth and about 1, 2, 3, 4, 5, 6, 7 or 8 weeks, the animals can be switched to a diet free of PB6, which can comprise regular feedings of a liquid milk replacer and/or a starter feed. Additional feed materials, e.g., grains and/or forages, can also be provided on a regular or ad libitum basis. In some examples, the young animals may be weaned immediately or shortly after the final feeding of PB6-supplemented milk replacer. In an embodiment, calves can be fed a PB6-supplemented milk replacer twice a day for the first 6 weeks after birth, after which the calves are switched to a PB6-free diet. Providing PB6 via liquid milk replacer during an initial feeding period after birth, e.g., 6 weeks, may improve the calves' early performance in a manner that also enhances long-term growth, thereby increasing the value of the resulting adult cattle for beef or dairy operations.

Feeding young animals the disclosed milk replacer products mixed with PB6 according to the methods disclosed herein may improve animal performance. In various embodiments, providing calves with a milk replacer mixed with a baseline dose of PB6 between birth and about 6 weeks of age may increase total weight gain and the intake of a concurrently-fed starter feed. Total feed efficiency may also be improved. In addition, providing calves with a milk replacer mixed with an enhanced dose of PB6, e.g., double or triple relative to baseline, between birth and about 3 or 6 weeks of age may increase total weight gain and total starter feed intake, while also improving milk replacer feed efficiency and in some examples, total feed efficiency. The aforementioned improvements in performance may be the most substantial in calves provided triple the baseline dose of PB6 for the first 3 weeks after birth and double the baseline dose for weeks 3-6 after birth. Performance improvements may be even more drastic in calves fed an ultra-enhanced PB6 dose, e.g., 5× baseline, for the first milk replacer feeding after birth, followed by an enhanced dose, e.g., 3× baseline, for the remainder of the initial 3-week period, and a less-enhanced dose, e.g., 2× baseline, for weeks 3-6. Gene sequencing of fecal samples collected from calves fed a milk replacer mixed with PB6 early after birth shows that such a feeding method may also accelerate microbiome maturation, especially when higher doses of PB6 are offered immediately after birth.

Implementations of the present disclosure are more particularly described in the following calf trials for illustrative purposes only. Numerous modifications and variations are within the scope of the present disclosure as will be apparent to those skilled in the art.

### EXAMPLES

Calf Trial 1

This study was conducted to assess the impacts of feeding calves milk replacer products supplemented with various direct-fed microbials (DFMs) under different feeding regimens.

The test subjects evaluated in the 6-week trial included 204 bull calves, all ranging from 2-5 days of age, that were sourced from Wisconsin sale barn facilities, co-mingled and transported to Eastern Missouri. Upon arrival, all calves were stratified by body weight and serum protein levels, and assigned randomly to separate treatment groups. The treatment groups were defined by the specific milk replacer product provided to the calves and the method of providing the milk replacer product to the calves over the duration of the experiment. Treatment group 1, the negative control group, was fed a milk replacer containing no DFMs. Treatment groups 2-4 were each fed the milk replacer containing a baseline dose of a different DFM. Each DFM provided to groups 2-4 was commercially available. Treatment group 5 was fed the milk replacer containing a DFM comprised of Bacillus subtilis PB6 at a baseline dose equal to that offered to groups 2-4. The DFMs fed to treatment groups 2-5 were provided according to the manufacturer recommendations. Twenty-four calves were assigned to treatment group 1, and 15 calves were assigned to each of groups 2-5.

The milk replacer mixed with the DFMs comprised Amplifier® Max PB, sold by Land O'Lakes, which is a milk and vegetable based milk replacer product comprised of 25 wt % crude protein and 17 wt % crude fat. About 1.50 pounds by dry weight of the milk replacer was provided daily to each calf in 2 meals of 0.75 pounds each, after mixing with hot water. All calves were also offered a commercially available calf starter comprising 20 wt % crude protein (Ampli-Calf® Warm Weather 20, sourced from Purina Animal Nutrition, LLC) on an ad libitum basis. The baseline dose of PB6 was about 4.3×10⁹ CFUs per head per day, split evenly between the 2 meals.

After 6 weeks of feeding, growth performance of the calves was evaluated by measuring total weight gain, total milk replacer intake, milk replacer feed efficiency, total starter feed intake, starter feed efficiency, and total feed efficiency. Because each of treatment groups 2-4 failed to deliver a growth response measurable by each of these parameters, data for these groups were pooled. The results are shown below in Table 1. All weights are listed in lbs.

TABLE 1

| | | | | (contrast P-values) | | | |
|---|---|---|---|---|---|---|---|
| | Performance parameter | | | | Group | Group | Groups |
| | Group 1 | Groups 2-4 | Group 5 | SEM | 1 vs. 2-4 | 1 vs. 5 | 2-4 vs. 5 |
| initial weight | 96.28 | 96.15 | 95.65 | 1.646 | 0.93 | 0.71 | 0.65 |
| weight at | 140.18 | 141.21 | 144.87 | 3.909 | 0.76 | 0.24 | 0.17 |
| week 6 | | | | | | | |
| total gain | 43.9 | 45.06 | 49.22 | 3.528 | 0.71 | 0.13 | 0.08 |
| total MR intake | 60.40 | 60.55 | 60.81 | 0.534 | 0.75 | 0.44 | 0.46 |
| MR feed | 1.53 | 1.57 | 1.31 | 0.237 | 0.85 | 0.35 | 0.1 |
| efficiency | | | | | | | |
| total starter | 31.17 | 31.77 | 35.61 | 3.902 | 0.86 | 0.26 | 0.14 |
| feed intake | | | | | | | |
| starter feed | 0.67 | 0.70 | 0.71 | 0.054 | 0.53 | 0.42 | 0.72 |
| efficiency | | | | | | | |
| total feed | 2.20 | 2.27 | 2.02 | 0.258 | 0.76 | 0.49 | 0.15 |
| efficiency | | | | | | | |

As shown in Table 1, mean total gain by the calves in groups 2-4 increased by a mere 2.6%, while total weight gain exhibited by group 5 calves (fed MR+PB6) increased by over 12% relative to the control. Total feed efficiency of the group 5 calves also improved compared to calves in groups 2-4, as did total starter feed intake. Total starter feed intake for group 5 calves increased by about 12.5% relative to the control, while total starter feed intake for calves in groups 2-4 only increased by less than 2% relative to the control. Thus, by providing the calves a consistent amount of PB6 in a milk replacer for the initial 6 weeks after birth, multiple performance improvements were observed, including improved weight gain, feed efficiency, and starter feed intake.

In addition to testing a variety of DFMs in milk replacer products, different feeding methods were also evaluated. The first method involved providing a baseline dose of each direct-fed microbial via a milk replacer. The second method involved doubling the baseline dose (2×) of each DFM during the first 3 weeks of the trial and reducing to the baseline dose thereafter. The third method involved tripling the baseline dose during the first week of the trial and reducing to the baseline dose thereafter. The results for the first method are shown below in Table 2.1, the second method in Table 2.2, and the third method in Table 2.3.

TABLE 2.1
Baseline

| | Group | Groups | Groups | Group |
|---|---|---|---|---|
| Performance parameter | 1 | 2-5 | 2-4 | 5 |
| initial weight (lbs.) | 96.28 | 96.10 | 96.43 | 95.09 |
| weight at week 6 (lbs.) | 140.18 | 140.29 | 138.97 | 144.27 |
| total gain (lbs.) | 43.9 | 44.19 | 42.53 | 49.18 |
| total MR intake (lbs.) | 60.40 | 60.17 | 60.18 | 60.14 |
| MR feed efficiency | 1.53 | 1.51 | 1.57 | 1.31 |
| total starter feed intake (lbs.) | 31.17 | 31.58 | 30.66 | 34.37 |
| starter feed efficiency | 0.67 | 0.69 | 0.70 | 0.66 |
| total feed efficiency | 2.20 | 2.20 | 2.27 | 1.97 |

TABLE 2.2
2X Baseline

| | Group | Groups | Groups | Group |
|---|---|---|---|---|
| Performance parameter | 1 | 2-5 | 2-4 | 5 |
| initial weight (lbs.) | 96.28 | 95.84 | 95.93 | 95.56 |
| weight at week 6 (lbs.) | 140.18 | 142.65 | 142.42 | 143.33 |
| total gain (lbs.) | 43.9 | 46.81 | 46.49 | 47.76 |
| total MR intake (lbs.) | 60.40 | 60.93 | 60.93 | 60.92 |
| MR feed efficiency | 1.53 | 1.53 | 1.59 | 1.35 |
| total starter feed intake (lbs.) | 31.17 | 33.36 | 32.80 | 35.06 |
| starter feed efficiency | 0.67 | 0.72 | 0.71 | 0.74 |
| total feed efficiency | 2.20 | 2.25 | 2.30 | 2.09 |

TABLE 2.3
3X Baseline

| | | | | | (P-value) |
|---|---|---|---|---|---|
| | Group | Groups | Groups | Group | Group 1 |
| Performance parameter | 1 | 2-5 | 2-4 | 5 | vs. 5 |
| initial weight (lbs.) | 96.28 | 96.15 | 96.09 | 96.30 | 0.99 |
| weight at week 6 (lbs.) | 140.18 | 143.44 | 142.25 | 147.01 | 0.17 |
| total gain (lbs.) | 43.9 | 47.30 | 46.16 | 50.71 | 0.13 |
| total MR intake (lbs.) | 60.40 | 60.74 | 60.53 | 61.38 | 0.14 |
| MR feed efficiency | 1.53 | 1.48 | 1.55 | 1.26 | 0.37 |
| total starter feed | 31.17 | 33.23 | 31.85 | 37.39 | 0.21 |
| intake (lbs.) | | | | | |
| starter feed efficiency | 0.67 | 0.70 | 0.69 | 0.73 | 0.36 |
| total feed efficiency | 2.20 | 2.17 | 2.23 | 1.99 | 0.52 |

As shown in Tables 2.1 through 2.3, the second (2× baseline) and third (3× baseline) feeding methods increased total gain for treatment groups 2-5 by 6.6% and 7.7% relative to the control animals in group 1, respectively. This increase was driven largely by the growth response exhibited by the calves in group 5 (fed PB6), which experienced an 8.4% increase in total gain under the second feeding method, and a 15.5% increase under the third feeding method, relative to the control animals not fed any DFMs in group 1. Feed efficiency for group 5 calves fed according to the third method also increased by 17.6% for milk replacer and 9.9% for total feed, compared to the group 1 animals. Total starter feed intake was also the highest for group 5 calves in each feeding regime, increasing by about 10.4% under the first approach, about 11% under the second approach, and about 16.6% under the third. Thus, feeding calves a milk replacer mixed with PB6 according to the third feeding method, in which the baseline PB6 dose was tripled during the first week after birth and reduced to the baseline dose thereafter resulted in substantial increases in total weight gain, the best milk replacer feed efficiency, and the highest amount of total starter feed intake. Feeding calves a milk replacer mixed with PB6 according to the second feeding method, in which the baseline PB6 dose was doubled during the first 3 weeks of the trial and reduced to the baseline dose thereafter, also resulted in improved weight gain, starter feed intake, milk replacer feed efficiency, and total feed efficiency relative to the control animals in group 1.

In order to determine the impact of each DFM on the microbiome of the calves, fecal samples were collected at the start of the trial (day 0) and at 3 weeks (day 21). DNA was isolated from the fecal samples and the V4 region of the bacterial 16S ribosomal gene was amplified by PCR. A cDNA library was created from the resulting PCR products and sequenced on the Illumina MiSeq platform. Resulting sequence reads were trimmed, quality checked, and rarefied to 4472 reads per sample.

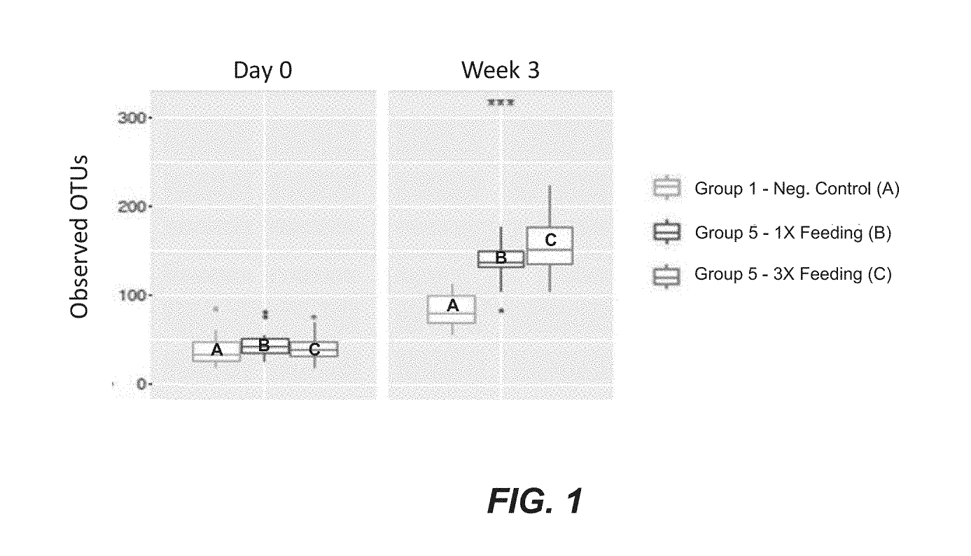

The diversity analysis results are provided in FIG. 1. As shown, the average measured alpha diversity for calves in group 1, the group 5 calves fed a baseline dose for the duration of the trial, and the group 5 calves fed triple the baseline PB6 dose during the first week after birth and reduced to the baseline dose thereafter, each began at Day 0 with similar levels of microbial diversity (represented by the observed number of operational taxonomic units (“OTUs”)). By day 21, however, the alpha diversity for group 5 calves exceeded that observed in group 1 calves. The diversity was the greatest for group 5 calves fed triple the baseline PB6 dose during the first week after birth and reduced to the baseline dose thereafter, although alpha diversity for group 5 calves fed the 1× (baseline) dose also improved. Thus, the microbiome data generated using this method indicates that inclusion of Bacillus subtilis PB6 in milk replacer at both 1× and 3× levels immediately after birth accelerated the maturity of the microbiome in young calves. In calves fed milk replacers containing other DFMs, the increase in alpha diversity was similar to that of the negative control group. An increasing level of population diversity with age is a common feature of microbiome development in young animals, and has been repeatedly demonstrated in dairy calves.

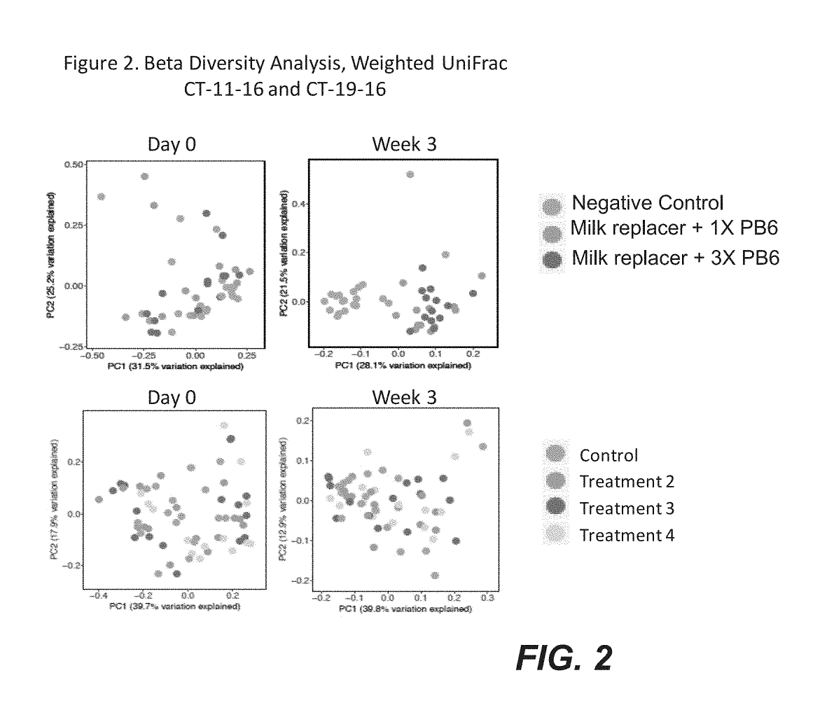

In addition, inclusion of PB6 in milk replacer had a statistically significant impact on inter-animal microbiome diversity. Specifically, the beta diversity data provided in FIG. 2 shows that microbiome samples from animals fed PB6-supplemented milk replacer at 1× and 3× levels beginning at birth clustered away from the control group at Day 21 of the trial (indicating less microbiome compositional homogeneity in the PB6-fed animals). No clustering was observed in samples collected on Day 0, nor in samples collected from calves fed milk replacers containing DFM products other than PB6. This shift in beta diversity correlated with the improvements in animal performance noted above, and may be driven at least in part by the accelerated maturity of the microbial community evidenced by the alpha diversity plot of FIG. 1.

Calf Trial 2

This study was conducted to confirm the effects of feeding calves a milk replacer product supplemented with Bacillus subtilis PB6 under different feeding regimens.

The test subjects evaluated in the 6-week trial included 72 bull calves ranging from 2-5 days of age and sourced from Wisconsin sale barn facilities. The calves were co-mingled and transported to Eastern Missouri for the trial. Upon arrival, all calves were stratified by body weight and serum protein levels, and assigned randomly to separate treatment groups. The treatment groups were defined by the specific feeding approach. Treatment group 1, the negative control group, was fed a milk replacer containing no DFMs. Treatment group 2 was fed a milk replacer containing PB6 at a baseline dose (1×) for the duration of the trial. Treatment group 3 was fed a milk replacer containing PB6 at double (2×) the baseline dose for the first 3 weeks of the trial, followed by the baseline dose (1×) for the remainder of the trial. Treatment group 4 was fed a milk replacer containing PB6 at five times (5×) the baseline dose for the first feeding, double (2×) the baseline dose from the remainder of feedings during the first 3 weeks of the trial, followed by the baseline dose (1×) for the remainder of the trial. Eighteen calves were assigned to teach treatment group.

The milk replacer mixed with PB6 comprised Cow's Match® WarmFront® PB, sold by Land O'Lakes, which is a milk and vegetable based milk replacer product comprised of 28 wt % crude protein and 10 wt % crude fat. About 2.50 pounds by dry weight of the milk replacer was provided daily to each calf in 2 meals of 1.25 pounds each, after mixing with hot water. All calves were also offered a commercially available calf starter comprising 22 wt % crude protein (Ampli-Calf®-22, sourced from Purina Animal Nutrition, LLC) on an ad libitum basis. The baseline dose of PB6 was about 4.3×10⁹ CFUs per head per day, split evenly between the 2 meals.

After 6 weeks of feeding, growth performance of the calves was evaluated by measuring total weight gain, total milk replacer intake, milk replacer feed efficiency, total starter feed intake, starter feed efficiency, and total feed efficiency. Raw results are shown below in Table 3.1, and P-values for the comparative data between the treatment groups shown in Table 3.2. All weights are listed in lbs.

TABLE 3.1

| | Group | Group | Group | Group |
|---|---|---|---|---|
| Performance parameter | 1 | 2 | 3 | 4 |
| initial weight | 96.63 | 96.96 | 96.88 | 96.64 |
| weight at week 7 | 167.27 | 171.77 | 177.22 | 180.16 |
| total gain | 70.64 | 74.81 | 80.33 | 83.53 |
| total MR intake | 102.32 | 99.59 | 103.30 | 103.65 |
| MR feed efficiency | 1.54 | 1.42 | 1.33 | 1.26 |
| total starter feed intake | 26.31 | 29.79 | 33.30 | 38.29 |
| starter feed efficiency | 0.35 | 0.38 | 0.40 | 0.45 |
| total feed efficiency | 1.89 | 1.79 | 1.73 | 1.71 |

TABLE 3.2

| | (contrast P-values) | | | | |
|---|---|---|---|---|---|
| | Group | Group | Group | Group 1 | Group 1 |
| Performance parameter | 1 vs.2 | 1 vs. 3 | 1 vs. 4 | vs. 2-4 | vs. 2-3 |
| initial weight | 0.87 | 0.91 | 0.99 | 0.90 | 0.94 |
| weight at week 6 | 0.49 | 0.15 | 0.06 | 0.09 | 0.05 |
| total gain | 0.51 | 0.14 | 0.04 | 0.08 | 0.04 |
| total MR intake | 0.28 | 0.71 | 0.61 | 0.94 | 0.61 |
| MR feed efficiency | 0.28 | 0.07 | 0.02 | 0.03 | 0.01 |
| total starter feed intake | 0.53 | 0.24 | 0.04 | 0.11 | 0.06 |
| starter feed efficiency | 0.59 | 0.32 | 0.06 | 0.16 | 0.09 |
| total feed efficiency | 0.27 | 0.08 | 0.05 | 0.04 | 0.03 |

As shown in Table 3.1, feeding the calves a milk replacer containing PB6 according to the third feeding approach (group 4 animals) resulted in an 18% increase in total weight gain relative to the control, which was the greatest total weight gain measured in the experiment. The first feeding approach (group 2) resulted in a 6% increase in total weight gain, and the second feeding approach (group 3) resulted in an increase of over 12%. Milk replacer feed efficiency also improved incrementally in groups 2 through 4, as did starter feed intake and total feed efficiency.

From the comparative data listed in Table 3.2, it is clear that increasing the colony forming units (CFUs) of PB6 offered via milk replacer early in the calves' lives, i.e., according to the second and third feeding approaches, can drastically improve animal growth, as calves fed according to these regimens gained over 9.5% more weight, on average, compared to calves fed according to the first approach. Group 3 and 4, together, also exhibited significantly increased weight gain compared to control animals (p<0.04). Feeding higher doses of PB6 early after birth also improved milk replacer and total feed efficiencies significantly (p<0.01 and 0.03, respectively) relative to control animals not provided any DFMs. The group 4 calves offered a 5× dose of PB6 only in the very first milk replacer feeding exhibited a 4% increase in total weight gain relative to group 3 animals offered the same PB6 dose throughout the trial, except for the initial feeding, thus indicating that feeding calves an ultra-enhanced dose of PB6 in the first milk replacer feeding after birth may further improve microbiome health and animal performance.

The data shown in Tables 1-3 demonstrate that Bacillus subtilis PB6, when fed to calves in a milk replacer, manipulates the diversity of the calves' microbiomes and enhances animal performance. The data also indicate that feeding higher PB6 doses early in the calves' lives may be critical to maximizing performance. Total weight gain and feed efficiency, in particular, were improved when increased concentrations of PB6 in milk replacer were offered to the calves immediately after birth.

To examine the statistical strength of the data generated in calf trials 1 and 2, the data were pooled and contrast p-values determined across the two experiments. The results are shown below in Table 4. In the second column, p-values are shown for each performance parameter measured when feeding calves a 1× dose of PB6 in trials 1 and 2. In the third column, p-values are shown for each performance parameter measured when feeding calves a 2× dose of PB6 in trial 1, and an initial 2× PB6 dose offered for weeks 1-3 followed by a 1× PB6 dose offered for weeks 3-6 in trial 2. In the final column, p-values are shown for each performance parameter measured when feeding calves a 3× PB6 dose in trial 1, and an initial 5× PB6 dose followed by a 2× dose offered for weeks 1-3 and a 1× dose offered for weeks 3-6 in trial 2. As shown, p-values are generally the lowest in the final column, indicating that the observed effects of feeding higher doses of PB6 earlier after birth were confirmed with greater statistical certainty than other approaches of feeding PB6 in a milk replacer. The improvements in animal performance are thus more substantial, and statistically more likely to occur, when feeding higher doses of PB6 in a milk replacer immediately after birth.

TABLE 4

| | Contrast p-values | | |
|---|---|---|---|
| | | | Trial 1 (3X) & |
| Performance | Trial 1 (1X) & | Trial 1 (2X) & | Trial 2 |
| parameter | Trial 2 (1X) | Trial 2 (2X→1X) | (5X→2X→1X) |
| initial weight | 0.78 | 0.89 | 0.97 |
| weight at week 6 | 0.28 | 0.21 | 0.03 |
| total gain | 0.22 | 0.08 | 0.01 |
| total MR intake | 0.26 | 0.57 | 0.37 |
| MR feed efficiency | 0.06 | 0.03 | 0.01 |
| total starter feed | 0.43 | 0.19 | 0.02 |
| intake | | | |
| starter feed | 0.8 | 0.11 | 0.04 |
| efficiency | | | |
| total feed efficiency | 0.04 | 0.09 | 0.01 |

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates, or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of feeding young livestock animals, the method comprising:
feeding the young livestock animals a milk replacer comprising a direct-fed microbial composition, wherein feeding the young livestock animals improves animal performance.

2. The method of claim 1, wherein the direct-fed microbial composition comprises Bacillus subtilis PB6.

3. The method of claim 1, wherein about 4.3×10⁹ CFUs of the direct-fed microbial composition are provided daily on a per-animal basis.

4. The method of claim 3, wherein the direct-fed microbial composition is provided daily on a per-animal basis between birth and about 3 weeks of age.

5. The method of claim 3, wherein the direct-fed microbial composition is provided daily on a per-animal basis between birth and about 6 weeks of age.

6. The method of claim 1, wherein about 8.6×10⁹ CFUs to about 12.9×10⁹ CFUs of the direct-fed microbial composition are provided daily on a per-animal basis.

7. The method of claim 6, wherein the direct-fed microbial composition is provided daily on a per-animal basis between birth and about 3 weeks of age.

8. The method of claim 6, wherein the direct-fed microbial composition is provided daily on a per-animal basis between birth and about 6 weeks of age.

9. The method of claim 1, wherein about 10.75×10⁹ CFUs of the direct-fed microbial composition are provided in a first meal after birth on a per-animal basis.

10. The method of claim 9, wherein after the first meal, about 8.6×10⁹ CFUs to about 12.9×10⁹ CFUs of the direct-fed microbial composition are provided daily between birth and about 3 to about 6 weeks of age.

11. The method of claim 1, wherein animal performance comprises total weight gain between birth and about 6 weeks of age.

12. The method of claim 1, wherein animal performance comprises total feed efficiency between birth and about 6 weeks of age.

13. The method of claim 1, wherein animal performance comprises milk replacer feed efficiency between birth and about 6 weeks of age.

14. The method of claim 1, further comprising feeding the young livestock animals a starter feed composition on an ad libitum basis.

15. The method of claim 14, wherein animal performance comprises total starter feed intake.
